(19) United States
(12) Patent Application Publication
(10) Pub. No.: US 2016/0357250 A1
(43) Pub. Date: Dec. 8, 2016

(54) WEARABLE DEVICE HAVING CONTROL PANEL

(71) Applicant: Samsung Electronics Co., Ltd., Suwon-si (KR)

(72) Inventors: Min-Soo KIM, Seoul (KR); Yong Seok BANG, Yongin-si (KR)

(21) Appl. No.: 15/170,340

(22) Filed: Jun. 1, 2016

(30) Foreign Application Priority Data
Jun. 2, 2015 (KR) 10-2015-0077720

(51) Int. Cl. G06F 3/01; G06F 1/16; G06F 1/26; H04B 5/00

(52) U.S. Cl. CPC G06F 3/011; H04B 5/0031; G06F 1/163; G06F 1/26

(57) ABSTRACT

A wearable device is provided. The wearable device includes a body comprising a device mounting portion for receiving a first electronic device, a strap extended with a specific length from the body to fix the body to a person at a proper position, a battery disposed in a portion of at least one of the body and the strap, a first electronic device configured to selectively attach to the device mounting portion, wherein, when the first electronic device is attached to the device mounting portion, the first electronic device selectively receives power from the battery.

### CROSS-REFERENCE TO RELATED APPLICATION(S)

This application claims the benefit under 35 U.S.C. §119(a) of a Korean patent application filed on Jun. 2, 2015 in the Korean Intellectual Property Office and assigned Serial number 10-2015-0077720, the entire disclosure of which is hereby incorporated by reference.

### TECHNICAL FIELD

The present disclosure relates to a wearable device. More particularly, the present disclosure relates to a wearable device having a control panel.

### BACKGROUND

In general, a portable electronic device may include a display. The display may include a touch sensor, and may output various outputs to the display according to an input operation of the touch sensor.

Recently, a portable electronic device can be more effectively used by interworking with various neighboring devices, instead of being used alone. For example, the electronic device may perform a function by interworking with a wearable electronic device which is worn on a human body of a user. According to an embodiment, the wearable device may include a watch-type wearable electronic device which is worn on a wrist of the user to perform at least a part of a function of the portable electronic device and a head mount technology (HMT) device or the like capable of providing the user with an image displayed from the display in a realistic manner.

In particular, the HMT device may provide the user with virtual reality or augmented reality in an image format, and may provide the user a more realistic game on the basis of the virtual reality or the augmented reality. In addition, the HMT device may recognize an action of the user, and may display a display screen in association with the recognized action. Accordingly, the user of the HMT device may watch a variety of content in a realistic manner.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a user with augmented reality or virtual reality.

In accordance with an aspect of the present disclosure, the head mount technology (HMT) device that uses an electronic device is provided. The HMT device includes a display, and may include a body for fixing the display in front of eyes of the user. According to an embodiment, the body may include an optical lens unit at positions corresponding to the two eyes of the user, and may provide the user with an image which is divided into two areas in the display by controlling the image in various ratios via the optical lens unit.

In accordance with another aspect of the present disclosure, the HMT device is provided. The HMT device includes providing the user with various applications (e.g., games, etc.) on the basis of the aforementioned virtual reality or augmented reality.

In accordance with another aspect of the present disclosure, the HMT device is provided. The HMT device includes an additional control panel to easily control a corresponding function of the application. According to an embodiment, the control panel may be electrically or operatively connected to an electronic device attached to the HMT device through wired communication or near-range wireless communication. Alternatively, for convenience of manipulation, the control panel may be electrically or operatively connected to the electronic device through near-range wireless communication.

However, the aforementioned control panel is provided separately from the HMT device, and thus is carried separately from the HMT device, which causes inconvenience. Due to the inconvenience in carrying, a possibility of losing the control panel is also increased. Further, since the control panel must be supplied with power, a charging operation is performed separately from the electronic device, which causes inconvenience.

Another aspect of the present disclosure is to provide a wearable device having a control panel.

In accordance with another aspect of the present disclosure, a wearable device having a control panel carried by being attached to an HMT device when not used, thereby providing convenience in use and eliminating a risk of losing, is provided.

In accordance with another aspect of the present disclosure, a wearable device having a control panel and implemented such that the control panel can be charged by only attaching the device without an additional charging operation is provided.

In accordance with another aspect of the present disclosure, a wearable device having a control panel and configured to supply auxiliary charging power to an attached electronic device is provided.

In accordance with another aspect of the present disclosure, a wearable device is provided. The wearable device includes a body comprising a device mounting portion for accommodating at least one external electronic device, a strap extended with a specific length from the body to fix the body to a proper position of a human body in a wearable manner, and a battery, disposed to a portion of at least one of the body and the strap, for supplying power when the at least one external electronic device is attached to the device mounting portion.

In accordance with another aspect of the present disclosure a wearable device is provided. The wearable device includes a body comprising a device mounting portion for accommodating at least one external electronic device, a strap extended with a specific length from the body to fix the body to a proper position of a human body in a wearable manner, a battery, disposed to the strap, for supplying power when the at least one external electronic device is attached to the device mounting portion, a first electronic device configured to be attached to the device mounting portion when used, and to be supplied with power of the battery, and a second electronic device electrically and operatively connected to the first electronic device by being detached from the device mounting portion when used.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

FIG. 1A is a front perspective view of a head mount technology (HMT) device according to various embodiments of the present disclosure;

FIG. 1B is a rear perspective view of the HMT device of FIG. 1A according to various embodiments of the present disclosure;

FIG. 1C illustrates a state in which an electronic device is attached to the HMT device of FIG. 1A according to various embodiments of the present disclosure;

FIG. 1D is a perspective view illustrating parts of the HMT device of FIG. 1A according to various embodiments of the present disclosure;

FIG. 2A illustrates a state in which an electronic device is mounted to an HMT device and thereafter is controlled by a control panel according to various embodiments of the present disclosure;

FIG. 2B is a perspective view of an electronic device according to various embodiments of the present disclosure;

FIG. 3A illustrates a state in which a control panel is attached to an HMT device according to various embodiments of the present disclosure;

FIG. 3B is a perspective view illustrating a structure of a control panel according to various embodiments of the present disclosure; and

FIG. 4 illustrates a structure of a battery disposed in a strap according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An expression “have”, “may have”, “include” or “may include” or the like used in the present document is intended to indicate a presence of a corresponding characteristic (e.g., a number, a function, an operation, or a constitutional element such as a component), and should be understood that there are additional possibilities of one or more other characteristics.

In the present document, an expression “A or B”, “A and/or B”, or “one or more of A and/or B” or the like may include all possible combinations of items enumerated together. For example, “A or B”, “at least one of A and B”, or “at least one of A or B” may indicate all cases where: (1) at least one A is included; (2) at least one B is included; and (3) at least one A and at least one B are both included.

Although expressions used in the present document such as “1^{st}”, “2^{nd}”, “first”, “second” or the like may be used to express various constitutional elements, it is not intended to limit an order and/or importance thereof For example, a 1^{st} user device and a 2^{nd} user device may indicate different user devices irrespective of an order or importance thereof For example, a 1^{st} constitutional element may be termed a 2^{nd} constitutional element, and similarly, the 2^{nd} constitutional element may be termed the 1^{st} constitutional element without departing from the scope of the present document.

When a certain constitutional element (e.g., the 1^{st} constitutional element) is mentioned as being “operatively or communicatively coupled with/to” or “connected to” a different constitutional element (e.g., the 2^{nd} constitutional element), it is to be understood that the certain constitutional element is directly coupled with/to another constitutional element or can be coupled with/to the different constitutional element via another constitutional element (e.g., a 3^{rd} constitutional element). On the other hand, when the certain constitutional element (e.g., the 1^{st} constitutional element) is mentioned as being “directly coupled with/to” or “directly connected to” the different constitutional element (e.g., the 2^{nd} constitutional element), it may be understood that another constitutional element (e.g., the 3^{rd} constitutional element) is not present between the certain constitutional element and the different constitutional element.

An expression “configured to” used in the present document may be interchangeably used with, for example, “suitable for”, “having the capacity to”, “designed to”, “adapted to”, “made to”, or “capable of” according to a situation. A term “configured to” may not imply only “specially designed to” in a hardware manner. Instead, in a certain situation, an expressed “a device configured to” may imply that the device is “capable of” together with other devices or components. For example, “a processor configured to perform A, B, and C” may imply a dedicated processor (e.g., an embedded processor) for performing a corresponding operation or a generic-purpose processor (e.g., central processing unit (CPU) or an application processor (AP)) capable of performing corresponding operations by executing one or more software programs stored in a memory device.

Terms used in the present document are for the purpose of describing particular embodiments only and are not intended to limit other embodiments. A singular expression may include a plural expression unless there is a contextually distinctive difference. Unless otherwise defined, all terms (including technical and scientific terms) used herein have the same meaning as commonly understood by those ordinarily skilled in the art to which various embodiments of the present document belong. It will be further understood that terms, such as those defined in commonly used dictionaries, should be interpreted as having a meaning that is consistent with their meaning in the context of the relevant art, and will not be interpreted in an idealized or overly formal sense unless expressly so defined herein. Optionally, the terms defined in the present document should not be interpreted to exclude the embodiments of the present disclosure.

An electronic device according to various embodiments of the present disclosure may include, for example, at least one of a smart phone, a tablet personal computer (PC), a mobile phone, a video phone, an e-book reader, a desktop PC, a laptop PC, a netbook computer, a workstation, a server, a personal digital assistant (PDA), a portable multimedia player (PMP), an Moving Picture Experts Group phase 1 or phase 2 (MPEG-1 or MPEG -2) Audio Layer 3 (MP3) player, a mobile medical device, a camera, and a wearable device. According to various embodiments, the wearable device may include at least one of an accessory-type device (e.g., a watch, a ring, a bracelet, an anklet, a necklace, glasses, contact lenses, or a head-mounted device (HMD)), a fabric- or clothes-integrated device (e.g., electronic clothes), a body attaching-type device (e.g., a skin pad or tattoo), or a body implantable device (e.g., an implantable circuit).

According to certain embodiments, the electronic device may be a home appliance. The home appliance may include, for example, at least one of a television (TV), a digital versatile disc (DVD) player, an audio player, a refrigerator, an air conditioner, a cleaner, an oven, a microwave oven, a washing machine, an air purifier, a set-top box, a home automation control panel, a security control panel, a TV box (e.g., Samsung HomeSync™, Apple TV™, or Google TV™), a game console (e.g., Xbox™, PlayStation™), an electronic dictionary, an electronic key, a camcorder, and an electronic picture frame.

According to other embodiments, the electronic device may include at least one of various medical devices (e.g., various portable medical measuring devices (e.g., a blood sugar measuring device, a hear rate measuring device, a blood pressure measuring device, a body temperature measuring device, etc.), magnetic resonance angiography (MRA), magnetic resonance imaging (MRI), computed tomography (CT), imaging equipment, ultrasonic instrument, etc.)), a navigation device, a global navigation satellite system (GNSS), an event data recorder (EDR), a flight data recorder (FDR), a car infotainment device, an electronic equipment for ship (e.g., a vessel navigation device, a gyro compass, etc.), avionics, a security device, a car head unit, an industrial or domestic robot, an automatic teller's machine (ATM) of financial institutions, point Of sales (POS) of shops, and Internet of things (e.g., a light bulb, various sensors, an electric or gas meter, a sprinkler device, a fire alarm, a thermostat, a streetlamp, a toaster, a fitness equipment, a hot water tank, a heater, a boiler, etc.).

According to certain embodiments, the electronic device may include at least one of furniture or a part of building/constructions, an electronic board, an electronic signature input device, a projector, and various measurement machines (e.g., water supply, electricity, gas, propagation measurement machine, etc.). The electronic device according to various embodiments of the present disclosure may be one or more combinations of the aforementioned various devices. The electronic device according to certain embodiments may be a flexible device. Further, the electronic device according to an embodiment of the present disclosure is not limited to the aforementioned devices, and may include a new electronic device developed through technological advancement.

Hereinafter, an electronic device according to various embodiments will be described with reference to the accompanying drawings. The term ‘user’ used in the present document may refer to a person who uses the electronic device or a device which uses the electronic device (e.g., an artificial intelligence (AI) electronic device).

According to various embodiments, an embodiment of the present disclosure illustrates and describes a device worn on a head portion, and is also applicable to various wearable devices that can be worn on other portions of a human body. According to an embodiment, an embodiment of the present disclosure describes a wearable device, but is also applicable to a device worn on various constructions other than the human body without departing from the technical scope of the present disclosure. According to an embodiment, the device of the present disclosure may serve as an electronic device operatively and/or electrically connected to an external electronic device.

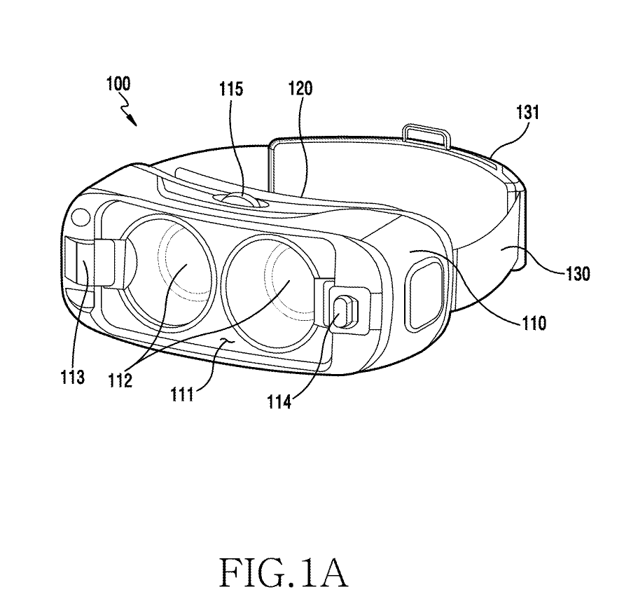

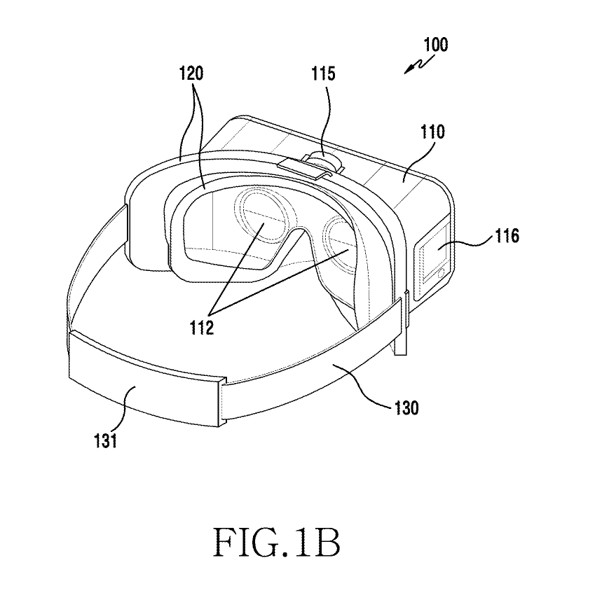

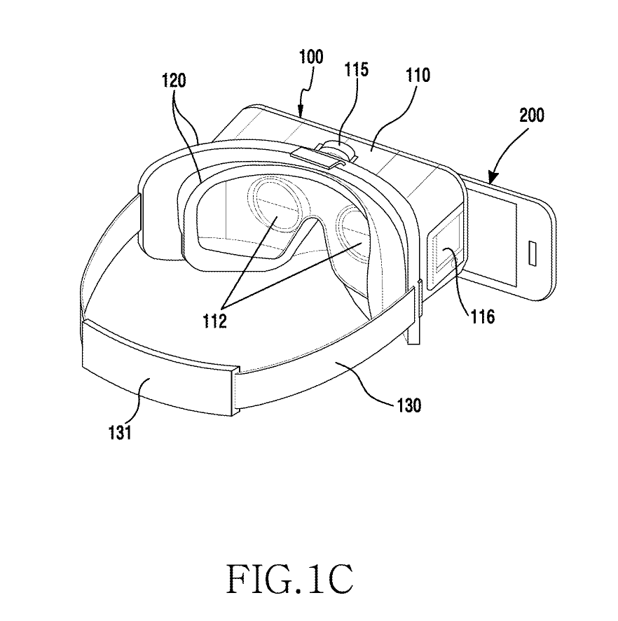

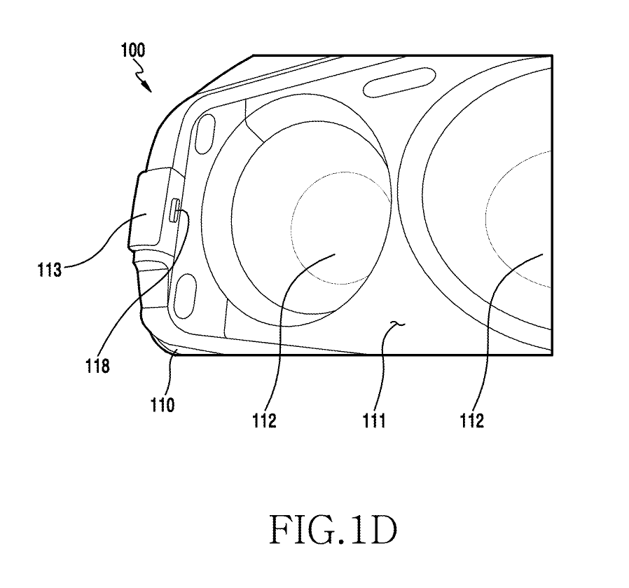

FIG. 1A is a front perspective view of a head mount technology (HMT) device 100 according to various embodiments of the present disclosure.

FIG. 1B is a rear perspective view of the HMT device of FIG. 1A according to various embodiments of the present disclosure.

FIG. 1C illustrates a state in which an electronic device is attached to the HMT device of FIG. 1A according to various embodiments of the present disclosure.

Referring to FIGS. 1A to 1C, the HMT device 100 may include a body 110 for accommodating an external electronic device and a strap 130 coupled to the body 110 to fix the device to a proper position (e.g., a head portion or the like) of a human body.

According to various embodiments, the body 110 may include a device mounting portion 111 in a front side to accommodate an external device (e.g., an electronic device or the like having a display). According to an embodiment, a pair of optical lens units 112 may be disposed to the device mounting portion 111 of the body 110. According to an embodiment, the optical lens units 112 may be disposed such that optical lenses of multiple ratios overlap with each other, and a user of the HMT device 100 may watch an image displayed in the display of the electronic device via the optical lens units 112 in accordance with an application which runs in the electronic device. According to an embodiment, a focus adjusting module 115 may be disposed to an upper side of the body 110 in a protruding manner, and an image of a display of an external electronic device may be adjusted to be clearer and then provided to the user. According to an embodiment, the focus adjusting module 115 may be a rotatable mechanical ring-type knob. However, the present disclosure is not limited thereto, and thus various well-known adjusting schemes may also be used.

According to various embodiments, the strap 130 may be disposed such that its length is adjustable to fit a head portion of the user. According to an embodiment, the strap 130 may include a battery 131 disposed in a center portion in general. According to an embodiment, the battery 131 may include a plurality of battery cells, and may be formed in a curved shape so as to be adaptable when worn on the human body.

According to various embodiments, a human body mounting portion 120 may be included in a rear side of the body 110 to be worn on a face including user's eyes. According to an embodiment, the human body mounting portion 120 may use a flexible material to adaptively associate with different users' faces. According to an embodiment, the human body mounting portion 120 may use a flexible maternal such as rubber, silicon, urethane, or the like which is harmless to the human body.

According to various embodiments, the body 110 may include a touch panel 116 in a lateral side thereof as an input means. According to an embodiment, the user wears the HMT device 100 on a head portion and thereafter manipulates the touch panel 116, so as to perform various functions such as a position adjustment of an object displayed in the display of the electronic device, a size adjustment of an image, or the like. However, the present disclosure is not limited thereto, and thus a simple physical manipulation button may be further included in addition to the touch panel.

According to various embodiments, the device mounting portion 111 may be formed in a recess shape capable of accommodating the electronic device 200. According to an embodiment, the device mounting portion 111 may accommodate the electronic device such that the display disposed to the front side of the electronic device 200 faces the optical lens unit. According to an embodiment, when the electronic device 200 is attached, the device mounting portion 111 may accommodate the electronic device 200 such that the rear side of the electronic device 200 protrudes externally from the body 110 or is disposed to be aligned with an outer surface of the body 110 or is disposed to be lower than the outer surface of the body 110.

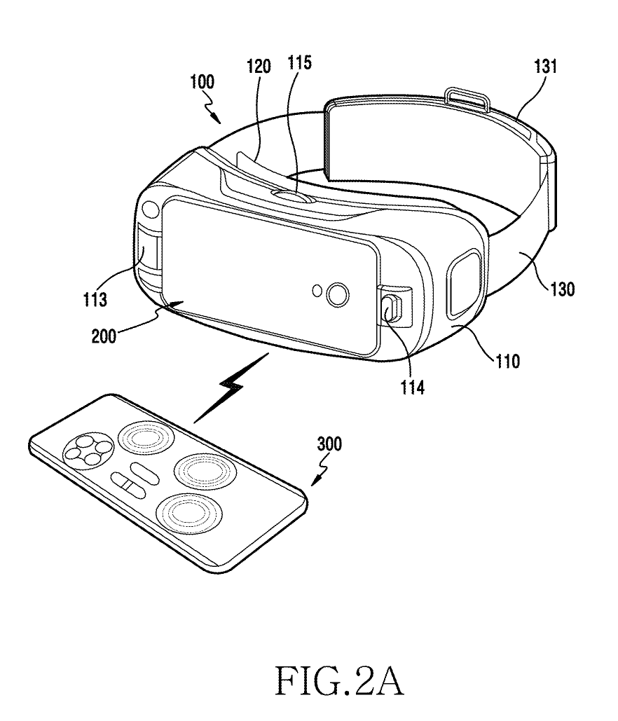

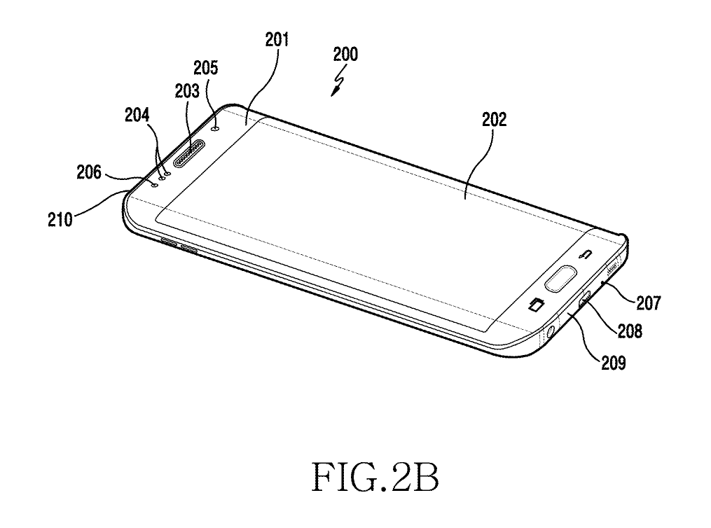

According to various embodiments, the HMT device 100 may include a fixing device capable of fixing the electronic device 200 to be accommodated. According to an embodiment, the fixing device may include a locker 114 disposed to one side of the device mounting portion 111. According to an embodiment, the locker 114 may accommodate an end portion of one side (e.g., an upper end portion 210 of the electronic device 200 of FIG. 2B) of the electronic device 200 to fix a position thereof. According to an embodiment, a hooking portion 113 capable of accommodating an end portion of the other side (e.g., a lower end portion 209 of the electronic device 200 of FIG. 2B) of the electronic device 200 may be disposed to a position opposite to the position at which the locker 114 of the device mounting portion 111 is disposed. According to an embodiment, the user may fix the electronic device 200 to the device mounting portion 111 of the HMT device 100 in such a manner that the lower end portion 209 of the electronic device 200 is first hooked at the hooking portion 113 and then the electronic device 200 is attached in a direction of the device mounting portion 111 along an axis of the hooking portion 113 so that the upper end portion 210 is interrupted by the locker 114.

FIG. 1D is a perspective view illustrating parts of the HMT device of FIG. 1 according to various embodiments of the present disclosure.

Referring to FIG. 1D, in the HMT device 100 according to the various embodiments of the present disclosure, the interface connector 118 attachable to an interface connector port of the electronic device 200 may be disposed to protrude inwardly from the device mounting portion 111 when the electronic device 200 is attached to the device mounting portion 111. According to an embodiment, the electronic device 200 attached to the device mounting portion 111 may be electrically connected to the interface connector 118 protruding from the device mounting portion 111, and the HMT device 100 connected to the electronic device 200 may be supplied with power from the electronic device 200 to manipulate the touch panel 116 or the like. However, the present disclosure is not limited thereto, and thus the HMT device 100 may also be supplied with power by the battery 131 disposed to the strap 130. According to an embodiment, the HMT device 100 may supply power to the electronic device 200 by means of the battery 131. According to an embodiment, when the electronic device 200 is connected, the HMT device 100 may automatically supply power to the electronic device 200 so as to be used as an auxiliary charging battery of the electronic device 200. This may facilitate long-term use of the electronic device 200. However, the present disclosure is not limited thereto, and thus a charging operation may be controlled to supply power of the battery 131 to the electronic device according to an additional manipulation (e.g., a manipulation of an additional physical button included in the HMT device 100) of the user.

FIG. 2A illustrates a state in which an electronic device is mounted to the HMT device 100 and thereafter is controlled by a control panel according to various embodiments of the present disclosure.

FIG. 2B is a perspective view of an electronic device according to various embodiments of the present disclosure.

Referring to FIGS. 2A and 2B, in a case where the electronic device 200 is attached to the device mounting portion 111 to perform a function (e.g., a game mode), the HMT device 100 may include the control panel 300 to control this case. According to an embodiment, the control panel 300 may serve as a manipulation unit for the game. According to an embodiment, the control panel 300 may be electrically, operatively connected through near-range wireless communication with the electronic device 200 attached to the device mounting portion 111. According to an embodiment, the control panel 300 may be connected through Bluetooth communication with the electronic device 200. However, the present disclosure is not limited thereto, and thus various near-range wireless communication schemes may also be used.

In this case, the electronic device 200 may be supplied with power via the battery 131 disposed to the strap 130 of the HMT device 100. According to an embodiment, the supplied power may be used as auxiliary charging power for charging internal power of the electronic device. However, the present disclosure is not limited thereto, and thus it may also be used as main power for driving the electronic device 200. According to an embodiment, power of the battery 131 may control a charging operation for charging an external electronic device through manipulation of the HMT device 100.

Referring to FIG. 2B, a display 202 may be disposed to a front side 201 of the electronic device 200. A speaker device 203 for receiving voice of an opposite party may be disposed to an upper side of the display 202. A microphone device 207 for transmitting voice of a user of the electronic device to the opposite part may be disposed to a lower side of the display 202.

According to an embodiment, components for performing various functions of the electronic device 200 may be disposed in proximity to a portion to which the speaker device 203 is disposed. The components may include at least one sensor module 204. The sensor module 204 may include, for example, at least one of an illumination sensor (e.g., an optical sensor), a proximity sensor, an infrared sensor, and an ultra sonic sensor. According to an embodiment, the component may include a camera device 205. According to an embodiment, the component may include a light-emitting diode (LED) indicator 206 for indicating state information of the electronic device 200 to the user.

According to various embodiments, the electronic device 200 may have an interface connector port 208 disposed to a lower end portion thereof. According to an embodiment, the interface connector port 208 may serve as a connection member for connecting a charging connector of a charging device to charge the electronic device 200. According to an embodiment, the interface connector port 208 may be electrically connected to the interface connector 118 disposed to protrude from the device mounting portion 111 of the HMT device 100. Accordingly, the electronic device 200 may accommodate the control of a manipulation panel (e.g., a touch panel) disposed to the body 110 of the HMT device 100. According to an embodiment, the HMT device 100 may deliver power of the battery 131 to the electronic device 200 through the interface connector 118. In this case, the HMT device 100 may deliver power of the battery 131 to the electronic device 200 or the control panel 300 (e.g., a smart phone, a control panel, etc.) either automatically or through user's manipulation.

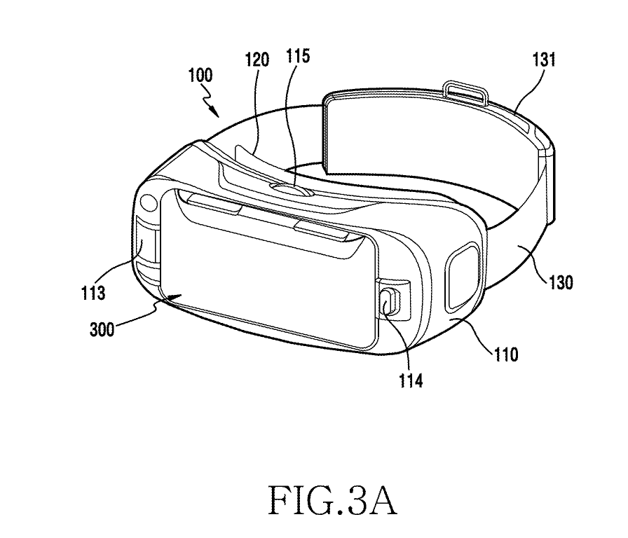

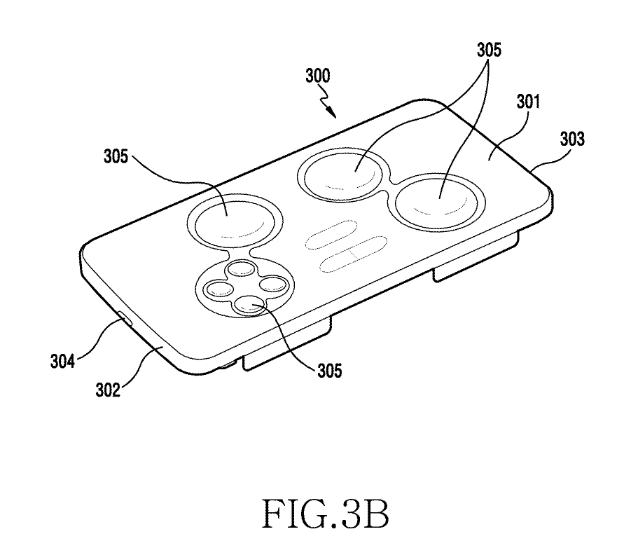

FIG. 3A illustrates a state in which a control panel is attached to a HMT device according to various embodiments of the present disclosure.

FIG. 3B is a perspective view illustrating a structure of a control panel according to various embodiments of the present disclosure.

Referring to FIG. 3A, if the HMT device 100 is not used, the electronic device 200 (e.g., a smart phone) may be detached from the device mounting portion 111 by means of the locker 114. According to an embodiment, the control panel 300 may be disposed to the device mounting portion 111 of the HMT device 100 from which the electronic device 200 is detached. According to an embodiment, the control panel 300 may be configured in general to have the same size as the electronic device 200, and thus the control panel 300 attached to the device mounting portion 111 may be utilized as a cover for protecting an optical lens unit from the outside when the HMT device 100 is not used. In this case, the control panel 300 is not necessarily carried separately from the HMT device 100, thereby providing convenience in carrying and eliminating a risk of losing. According to various embodiments, the control panel 300 may be attached or detached by means of the hooking portion 113 and the locker 114 disposed to the device mounting portion 111 of the HMT device 100.

Referring to FIG. 3B, the control panel 300 may be formed in general to have a size suitable for being attached to the device mounting portion 111. According to an embodiment, the control panel 300 may include an upper side 301 including at least one manipulation button 305 and a plurality of lateral sides extended from the upper side 301. According to an embodiment, the control panel 300 may include a first end portion 302 hooked at the hooking portion 113 disposed to the device mounting portion 111 of the HMT device 100 and a second end portion 303 for fixing by means of the locker 114 of the device mounting portion 111. According to an embodiment, the first end portion 302 may include an interface connector port 304 to be electrically connected to the interface connector 118 disposed to protrude from the device mounting portion 111. According to an embodiment, as a device supplied with power for driving the control panel 300, the interface connector port 304 of the control panel 300 may be configured to be commonly connected to a charging port of a charging device or the interface connector 118 of the device mounting portion 111.

According to various embodiments, when the HMT device 100 is not used, it may be carried by attaching the control panel 300 to the device mounting portion 111 so as to be used as a cover. In this case, since the interface connector 118 of the device mounting portion 111 is coupled with the interface connector port 304 of the control panel 300, the control panel 300 can be charged when the HMT device 100 is not used.

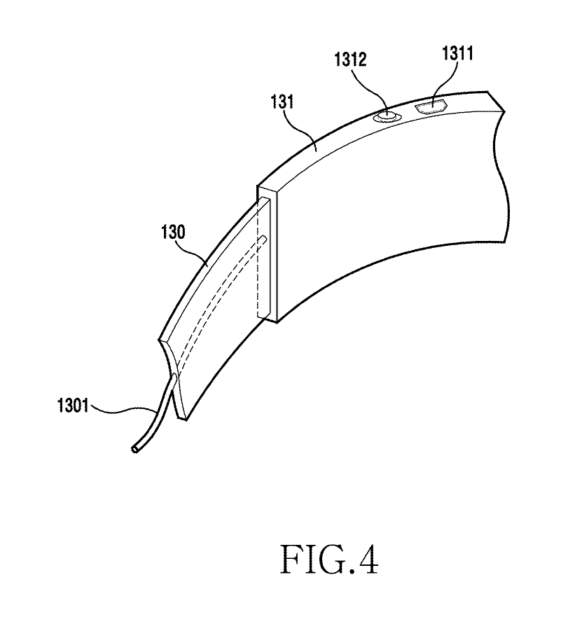

FIG. 4 illustrates a structure of a battery disposed in a strap according to various embodiments of the present disclosure.

Referring to FIG. 4, the strap 130 of the HMT device 100 may include the battery 131. According to an embodiment, the battery 131 may include an electrical connection member 1301 electrically connected to the interface connector 118 protruding from the aforementioned device mounting portion via the strap 130. According to an embodiment, the electrical connection member 1301 may be built-in inside the strap 130 or may be disposed separately from the strap 130. According to an embodiment, the electrical connection member 1301 may be disposed in an insert molding manner to the strap 130. According to an embodiment, a session cable, a flexible printed circuit (FPC), or the like may be used as the electrical connection member 1301.

According to various embodiments, the battery 131 may include a charging port 1311 for charging an internal battery cell and an operational button 1312 for operating the battery 131. According to an embodiment, the operational button 1312 may be a power supply start/stop button for supplying power of the battery 131 to an external device (e.g., an electronic device, a control panel, etc.) to be attached using the device mounting portion 111 through user's manipulation as described above.

Although the battery 131 is disposed to the strap 130 according to an embodiment of the present disclosure, the present disclosure is not limited thereto. For example, the battery 131 may be disposed in various positions at which it can be accommodated by the HMT device 100. According to an embodiment, the battery 131 may also be disposed to the body 110 of the HMT device 100. In this case, the electrical connection member of the battery may be physically connected directly by a specific contact device (a C clip or the like) with the interface connector 118.

According to various embodiments, if the control panel is attached to the HMT device, an operational connection with the electronic device may be automatically released, and if it is detached for use from the HMT device, may be automatically connected to the electronic device.

According to various embodiments, when the control panel is attached to the HMT device, only a charging operation may be performed by using power supplied from the HMT device while turning its own power OFF. According to an embodiment, when the control panel is detached from the HMT device, it may be controlled such that power is automatically turned ON.

Detecting of attachment/detachment for automatically controlling the function of the aforementioned control panel may be performed by detecting that the interface connector is attached to the interface connector port of the control panel. However, the present disclosure is not limited thereto, and thus the attachment/detachment may also be detected by means of a locker and a hooking portion for interrupting the electronic device or the control panel.

According to various embodiments, when the HMT device is not used, it is carried by accommodating a control panel, thereby providing convenience in carrying and eliminating a possibility of losing. Further, since auxiliary power is supplied while the control panel or the electronic device is attached, it is possible to facilitate long-term use of the electronic device and convenient charging of the control panel.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A wearable device comprising:
a body comprising a device mounting portion for accommodating a first electronic device or a second electronic device;
a strap extended with a specific length from the body to fix the body to a person at a proper position; and
a battery disposed in a portion of at least one of the body and the strap,
wherein, when the second electronic device is attached to the device mounting portion, the second electronic device covers the wearable device.

2. The wearable device of claim 1,
wherein the wearable device is configured to be attached to a head of the person, and
wherein, when the first electronic device is attached to the device mounting portion, the first electronic device is configured to display content.

3. The wearable device of claim 2, wherein the device mounting portion comprises a fixing device for fixing the first electronic device to the device mounting portion.

4. The wearable device of claim 2, further comprising a first interface connector port for coupling the wearable device to the first electronic device,
wherein the device mounting portion comprises a first interface connector that is coupled to the battery and protruding inwardly from the device mounting portion, and
wherein, when the first electronic device is attached to the device mounting portion, the first electronic device is coupled to the first interface connector port.

5. The wearable device of claim 4, further comprising a manipulation button disposed between the first interface connecter and the battery, the manipulation button being configured to selectively supply power.

6. The wearable device of claim 5, wherein the power is provided from the battery.

7. The wearable device of claim 6, wherein, when the first electronic device is attached to the device mounting portion, the power of the battery is automatically supplied to the first electronic device.

8. The wearable device of claim 1, wherein, when the first electronic device is attached to the device mounting portion, the first electronic device receives power from the battery.

9. The wearable device of claim 1, wherein, when the first electronic device is attached to the device mounting portion, the second electronic device is configured to couple operatively to the first electronic device.

10. The wearable device of claim 9, wherein the second electronic device is coupled to the first electronic device through near-field wireless communication.

11. The wearable device of claim 1, wherein the device mounting portion comprises a second interface connector that is coupled to the battery and protruding inwardly from the device mounting portion, and
wherein the second interface connector is coupled to a second interface connector port of the second electronic device.

12. The wearable device of claim 11, wherein, when the second electronic device is attached to the device mounting portion, the second electronic device is supplied with charging power through the second interface connector.

13. The wearable device of claim 12, further comprising a manipulation button disposed between the second interface connector and the battery, the manipulation button being configured to selectively supply power.

14. The wearable device of claim 1, wherein the second electronic device comprises a control panel for controlling an image displayed through the first electronic device.

15. A wearable device comprising:
a body comprising a device mounting portion for accommodating a first electronic device;
a strap extended with a specific length from the body to fix the body to a person at a proper position;
a battery disposed in the strap;
a first electronic device configured to:
attach to the device mounting portion, and
selectively receive power from the battery when attached to the device mounting portion; and
a second electronic device configured to:
attach to the device mounting portion, and
couple to the first electronic device when detached from the device mounting portion.

16. The wearable device of claim 15,
wherein the device mounting portion comprises an interface connector coupled to the battery and protruding inwardly from the device mounting portion, and
wherein, when the first electronic device is attached to the device mounting portion, the first electronic device is coupled to the interface connector.

17. The wearable device of claim 15, wherein, when the second electronic device is attached to the device mounting portion, the second electronic device covers the wearable device.

18. The wearable device of claim 17,
wherein the device mounting portion comprises an interface connector coupled to the battery and protruding inwardly from the device mounting portion, and
wherein, when the second electronic device is attached to the device mounting portion, the interface connector is coupled to an interface connector port of the second electronic device.

19. The wearable device of claim 18, wherein when the second electronic is attached to the device mounting portion, the second electronic device is configured to selectively receive charging power through the interface connector.

20. The wearable device of claim 15,
wherein the first electronic device comprises a display configured to output content through the wearable device, and
wherein the second electronic device includes a control panel coupled to the first electronic device through near-range communication.
